(19) United States
(12) Patent Application Publication
(10) Pub. No.: US 2018/0288474 A1
(43) Pub. Date: Oct. 4, 2018

(54) BROADCAST SIGNAL PROCESSING APPARATUS AND METHOD FOR CONTROLLING SAME

(71) Applicant: SAMSUNG ELECTRONICS CO., LTD., Suwon-si (KR)

(72) Inventor: Young-jin LEE, Suwon-si (KR)

(73) Assignee: SAMSUNG ELECTRONICS CO., LTD., Suwon-si (KR)

(21) Appl. No.: 15/761,718

(22) PCT Filed: Jun. 15, 2016
(86) PCT No.: PCT/KR2016/006319

§ 371 Date: Mar. 20, 2018

(30) Foreign Application Priority Data
Sep. 21, 2015 (KR) 10-2015-0133329

(51) Int. Cl. H04N 21/438; H04H 20/02; H04N 21/4402

(52) U.S. Cl. CPC H04N 21/4382; H04N 21/2393; H04N 21/440218; H04H 20/02

(57) ABSTRACT

Disclosed are a broadcast signal processing apparatus including: a signal receiver configured to receive a broadcast signal; a signal converter configured to convert and output the received broadcast signal into at least one of a first retransmission signal different in frequency from the received broadcast signal and a second retransmission signal different in signal transmission format from the received broadcast signal; a first signal output section configured to output the first retransmission signal; and a second signal output section configured to output the second retransmission signal, and a method of controlling the same.

### TECHNICAL FIELD

The present invention relates to a broadcast signal processing apparatus and a method of controlling the same, and more particularly to a broadcast signal processing apparatus and a method of controlling the same, in which a received broadcast signal is retransmitted by converting a carrier frequency or signal transmission formats.

### BACKGROUND ART

The vestigial sideband (VSB) transmission adopted for digital broadcasting as North American and Korean digital broadcasting standards may be deteriorated in reception performance under poor channel environments since it is a single carrier method. In particular, a portable or mobile broadcasting receiver is further required to be strong on channel variation and noise, and therefore the reception performance is further deteriorated when mobile service data is transmitted by the VSB transmission

Accordingly, the related art has developed a broadcast signal retransmission apparatus for amplifying a received broadcast signal and then retransmitting it to an indoor broadcast signal receiving apparatus or the like.

### DISCLOSURE

### Technical Problem

However, the related art has a problem that interference between an input signal and an output signal may increases since the broadcast signal retransmission apparatus directly transmits a received broadcast signal without converting a carrier frequency.

Further, the related art has a problem that the received broadcast signal is transmitted and received through only a network since it is not converted to have other signal transmission formats such as a universal serial bus (USB) format and the like, and thus a portable display device or the like incapable of receiving the broadcast signal through the network cannot provide an image based on the broadcast signal to a user.

Last, the related art has a problem that the received broadcast signal is just amplified without correcting an error and retransmitted to enhance signal reception of indoor devices, and therefore an error caused by an external factor is amplified and retransmitted together.

### Technical Solution

To solve the foregoing problems of the related art, there is provided a broadcast signal processing apparatus designed to retransmit a received broadcast signal through a carrier of a different frequency or retransmit the received broadcast signal converted to have a different signal transmission format.

To achieve the foregoing objects, there is provided a broadcast signal processing apparatus including: a signal receiver configured to receive a broadcast signal; a signal converter configured to convert and output the received broadcast signal into at least one of a first retransmission signal different in frequency from the received broadcast signal and a second retransmission signal different in signal transmission format from the received broadcast signal; a first signal output section configured to output the first retransmission signal; and a second signal output section configured to output the second retransmission signal.

The signal converter may include a demodulator configured to perform demodulation with regard to the received broadcast signal, thereby applying the demodulation to the received broadcast signal.

The demodulator may include a forward error correcting (FEC) section configured to correct an error, thereby correcting an error such as noise and the like involved in the received broadcast signal.

The signal converter may include a remodulator configured to remodulate and output the demodulated broadcast signal into the first retransmission signal, thereby retransmitting the received broadcast signal by converting a frequency.

The signal converter may further include a converter configured to convert the demodulated broadcast signal into the second retransmission signal, thereby retransmitting the received broadcast signal by converting a signal transmission format.

The broadcast signal processing apparatus may further include a first switch configured to selectively connect the signal receiver and the first signal output section while bypassing the signal converter, wherein the first signal output section outputs a third retransmission signal of the broadcast signal received through the first switch, thereby transmitting the received broadcast signal without undergoing any conversion.

The signal receiver and the first signal output section may be connected through the first switch when an error degree of the broadcast signal is lower than or equal to a predetermined threshold, thereby quickly performing a process since the received broadcast signal is retransmitted as it is when the broadcast signal has a low error degree.

The broadcast signal processing apparatus may further include a second switch configured to selectively connect the demodulator and the remodulator, wherein the second switch disconnects the demodulator and the remodulator when the signal receiver and the first signal output section are connected through the first switch, thereby selectively disconnecting the demodulator and the remodulator.

The demodulator may further include a third switch configured to make the received broadcast signal selectively bypass the FEC section, thereby converting the frequency or the signal transmission format without correcting the error when the broadcast signal satisfies a specific condition.

The broadcast signal processing apparatus may further include a user command input section, wherein the signal converter converts and outputs the broadcast signal into at least one of the first retransmission signal and the second retransmission signal based on a user's control command input through the user command input section, thereby allowing a user to input a control command for converting the broadcast signal.

The signal converter may convert and output the broadcast signal into at least one of the first retransmission signal and the second retransmission signal based on characteristics of an external signal receiving apparatus, thereby converting the broadcast signal by taking the characteristics of the external apparatus into account.

The characteristics of the external signal receiving apparatus include the kind of signal processible by the external signal receiving apparatus, thereby considering the kind of signals processible by the external apparatus.

The characteristics of the external signal receiving apparatus may include a request of the external signal receiving apparatus for the first retransmission signal or the second retransmission signal to the signal converter, thereby considering the request made by the external apparatus for converting the signal.

The signal converter may convert and output the broadcast signal into at least one of the first retransmission signal and the second retransmission signal based on characteristics of the received broadcast signal, thereby converting the broadcast signal by taking the characteristics of the received broadcast signal into account.

The characteristics of the broadcast signal may include at least one of the content of the broadcast signal, the signal transmission format, and the error degree, thereby considering various characteristics of the broadcast signal.

The broadcast signal processing apparatus may further include an output selection configured to output information about a signal output as converted from the received broadcast signal between the first retransmission signal and the second retransmission signal, thereby providing the information to a user.

Further, to achieve the foregoing objects, there is provided a method of controlling a broadcast signal processing apparatus, including: by a signal receiver, receiving a broadcast signal and outputting the broadcast signal to a signal converter; by a signal converter, converting the received broadcast signal into at least one of a first retransmission signal different in frequency from the received broadcast signal and a second retransmission signal different in signal transmission format from the received broadcast signal, and outputting the converted broadcast signal to corresponding output section; and by a first signal output section or a second signal output section, outputting at least one of the corresponding retransmission signals.

The converting and outputting of the received broadcast signal may include performing demodulation with regard to the received broadcast signal, thereby applying the demodulation to the received broadcast signal.

The demodulator may include a forward error correcting (FEC) section configured to correct an error, thereby correcting an error such as noise and the like involved in the received broadcast signal.

The converting and outputting of the received broadcast signal may include remodulating and outputting the demodulated broadcast signal into the first retransmission signal, thereby retransmitting the received broadcast signal by converting a frequency.

The converting and outputting of the received broadcast signal into at least one of the first retransmission signal and the second retransmission signal may include converting the demodulated broadcast signal into the second retransmission signal different in broadcast format from the broadcast signal, thereby retransmitting the received broadcast signal by converting a signal transmission format.

The receiving and outputting of the broadcast signal to the signal converter may include making the received broadcast signal selectively bypass the signal converter, and the transmitting at least one of the first retransmission signal and the second retransmission signal to the outside may include outputting a third retransmission signal of the broadcast signal received when the received broadcast signal bypasses the signal converter, thereby transmitting the received broadcast signal without undergoing any conversion.

The receiving and outputting of the broadcast signal to the signal converter may include making the broadcast signal bypass the signal converter when an error degree of the broadcast signal is lower than or equal to a predetermined threshold, thereby quickly performing a process since the received broadcast signal is retransmitted as it is when the broadcast signal has a low error degree.

The performing of the demodulation may include making the received broadcast signal selectively bypass the FEC section, thereby converting the frequency or the signal transmission format without correcting the error when the broadcast signal satisfies a specific condition.

The converting and outputting of the received broadcast signal into at least one of the first retransmission signal and the second retransmission signal may include converting and outputting of the received broadcast signal into at least one of the first retransmission signal and the second retransmission signal, thereby allowing a user to input a control command for converting the broadcast signal.

The converting and outputting of the received broadcast signal into at least one of the first retransmission signal and the second retransmission signal may include converting and outputting the broadcast signal into at least one of the first retransmission signal and the second retransmission signal based on characteristics of an external signal receiving apparatus, thereby converting the broadcast signal by taking the characteristics of the external apparatus into account.

The characteristics of the external signal receiving apparatus include the kind of signal processible by the external signal receiving apparatus, thereby considering the kind of signals processible by the external apparatus.

The characteristics of the external signal receiving apparatus may include a request of the external signal receiving apparatus for the first retransmission signal or the second retransmission signal to the signal converter, thereby considering the request made by the apparatus for converting the signal.

The converting and outputting of the received broadcast signal into at least one of the first retransmission signal and the second retransmission signal may include converting and outputting the broadcast signal into at least one of the first retransmission signal and the second retransmission signal based on characteristics of the received broadcast signal, thereby converting the broadcast signal by taking the characteristics of the received broadcast signal into account.

The characteristics of the broadcast signal may include at least one of the content of the broadcast signal, the signal transmission format, and the error degree, thereby considering various characteristics of the broadcast signal.

The method may further include outputting information about a signal output as converted from the received broadcast signal between the first retransmission signal and the second retransmission signal, thereby providing the information to a user.

### Advantageous Effects

As described above, according to the present invention, the broadcast signal processing apparatus is decreased in frequency interference between a received broadcast signal and a transmitted broadcast signal, and transmits the received broadcast signal converted to have a different signal transmission format so that other display apparatuses incapable of receiving a broadcast signal can also provide an image based on the broadcast signal to a user.

### DESCRIPTION OF DRAWINGS

FIG. 1 illustrates an example of a broadcast signal processing apparatus according to one embodiment of the present invention.

FIG. 2 is a block diagram for describing a basic operation of a broadcast signal processing apparatus according to one embodiment of the present invention.

FIG. 3 is a block diagram of a basic configuration of a broadcast signal processing apparatus according to one embodiment of the present invention.

FIG. 4 is a block diagram of a general configuration of a broadcast signal processing apparatus according to one embodiment of the present invention.

FIG. 5 is a perspective view of a broadcast signal processing apparatus according to one embodiment of the present invention.

FIG. 6 is a block diagram of the broadcast signal processing apparatus according to one embodiment of the present invention based on the perspective view of FIG. 6.

FIG. 7 is a block diagram of a broadcast signal processing apparatus further comprising a communicator according to one embodiment of the present invention.

FIG. 8 shows a screen of an external apparatus that receives a broadcast signal and asks a user about conversion of a frequency according to one embodiment of the present invention.

FIG. 9 shows a screen of an external apparatus that receives a broadcast signal and asks a user about conversion of the broadcast signal according to one embodiment of the present invention.

FIG. 10 is a basic flowchart of controlling a broadcast signal processing apparatus according to one embodiment of the present invention.

FIG. 11 is a flowchart of controlling a broadcast signal processing apparatus, which a broadcast signal bypasses a signal converter in accordance with an error degree, according to one embodiment of the present invention.

FIG. 12 is a flowchart of controlling a broadcast signal processing apparatus, in which a received broadcast signal bypasses a forward error corrector (FEC) when a specific condition is satisfied, according to one embodiment of the present invention.

### BEST MODE

Below, embodiments of the present invention will be described with reference to accompanying drawings so as to be easily realized by a person having ordinary skill in the art to which the present invention pertains. The present invention may be materialized variously without being limited to the embodiments set forth herein. To describe the present invention more clearly, unrelated parts are omitted, and like numerals refer to the same or similar elements throughout the specification.

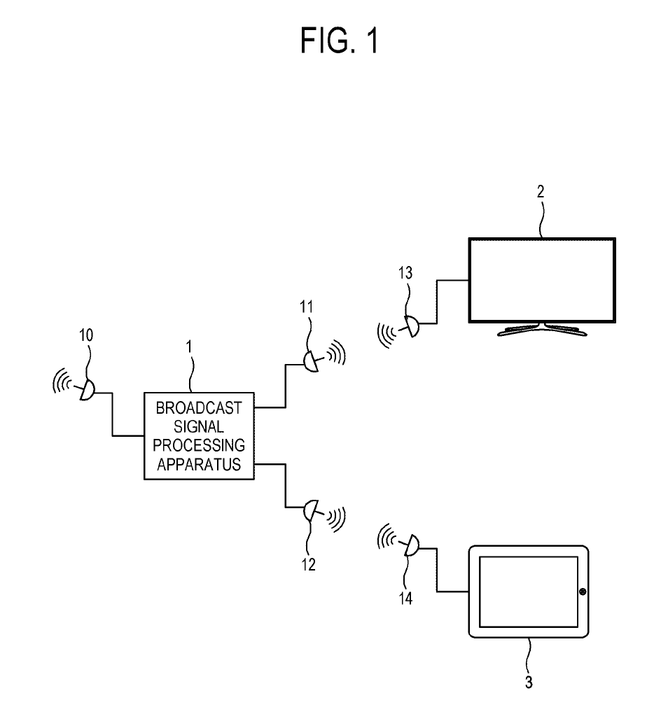

FIG. 1 illustrates an example of a broadcast signal processing apparatus according to one embodiment of the present invention. The broadcast signal processing apparatus 1 receives a broadcast signal transmitted from a broadcasting station, a relay and the like outside through a reception antenna 10. The broadcast signal processing apparatus 1 processes and retransmits the received broadcast signal, in which the received broadcast signal is converted to be different in a carrier frequency or a signal transmission format. The broadcast signal may be transmitted through a transmission antenna 11 or 12.

The display apparatus 2 capable of receiving a broadcast signal receives a retransmission signal, a frequency of which is converted, from the broadcast signal processing apparatus through a reception antenna 13, and displays an image based on the received retransmission signal.

The display apparatus 3 incapable of directly receiving a broadcast signal receives a retransmission signal, a transmission signal format of which is converted to be different from the broadcast signal, through a reception antenna 14, and displays an image based on the received retransmission signal.

The retransmission signal having the converted frequency may be referred to as a first retransmission signal in claims of the present application, and the retransmission signal converted to be different in the transmission signal format may be referred to as a second retransmission signal in claims of the present application.

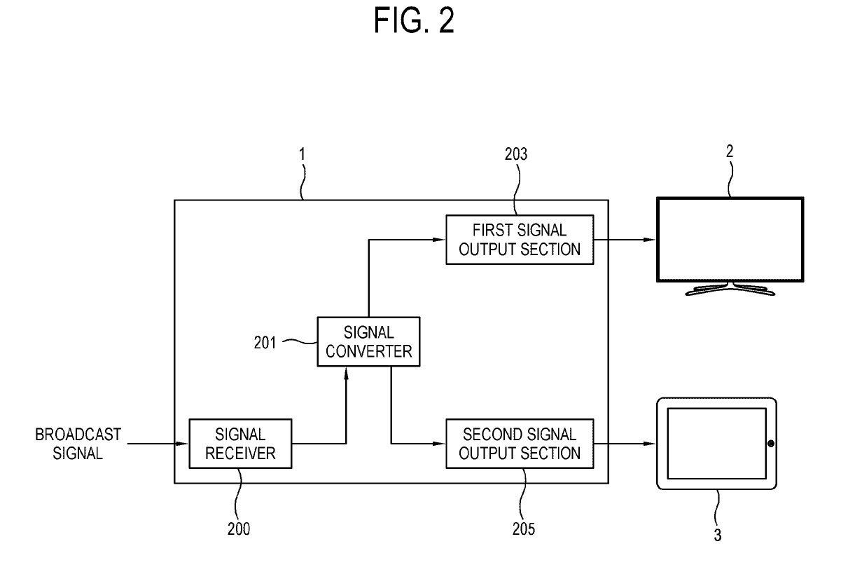

FIG. 2 is a block diagram for describing a basic operation of a broadcast signal processing apparatus according to one embodiment of the present invention. To receive a broadcast signal and transmit the received broadcast signal having the converted frequency or the converted transmission signal format, the broadcast signal processing apparatus includes a signal receiver 200, a signal converter 201, a first signal output section 203 and a second signal output section 205.

The signal receiver 200 receives a broadcast signal transmitted from the broadcasting station, and provides the received broadcast signal to the signal converter 201. To receive the broadcast signal, the signal receiver 200 may connect with the reception antenna 10 or may internally include the reception antenna 10.

The signal converter 201 converts the received broadcast signal into the first retransmission signal having a different frequency and outputs it to the first signal output section 203; and converts the received broadcast signal into the second retransmission signal having a different signal transmission format and outputs it to the second signal output section 205. The signal converter 201 may convert the received broadcast signal into at least one of the first retransmission signal and the second retransmission signal, in which the selection and selection reference will be described later.

The first signal output section 203 transmits the first retransmission signal. To transmit the signal, the first signal output section 203 may connect with the external transmission antennas 11 and 12 or may internally include the transmission antennas 11 and 12.

The second signal output section 205 transmits the second retransmission signal. To transmit the signal, the second signal output section 205 may connect with the external transmission antennas 11 and 12, or may internally include the transmission antennas 11 and 12.

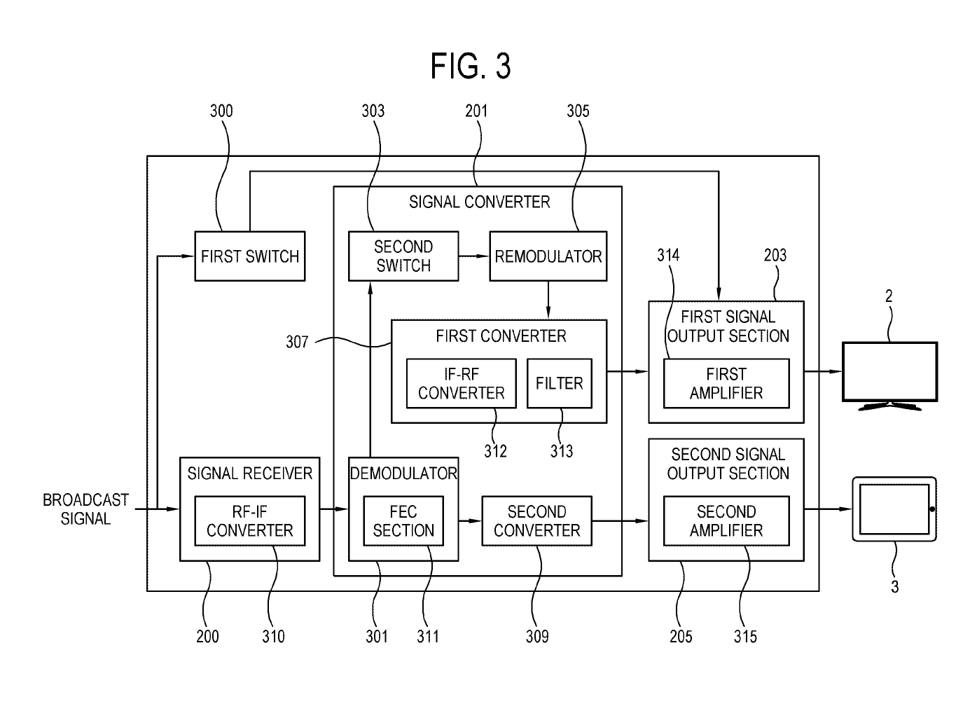

FIG. 3 is a block diagram of a basic configuration of a broadcast signal processing apparatus according to one embodiment of the present invention. According to one embodiment of the present invention, the broadcast signal processing apparatus 1 may further include a first switch 300 for selectively connecting the signal receiver 200 and the signal output section so that the received broadcast signal can be transmitted bypassing the signal converter 201, and a second switch 303 for blocking the broadcast signal so that the broadcast signal cannot be introduced into the signal converter 201.

The first switch 300 is connected between the signal receiver 200 and the first signal output section 203. The first switch 300 selectively connects the signal receiver 200 and the first signal output section 203 so that the received broadcast signal can bypass the signal converter 201 and be transmitted to the first signal output section 203 under control of the signal converter 201.

The second switch 303 is connected between a demodulator 301 and a remodulator 305 inside the signal converter 201, and selectively disconnects the demodulator 301 and the remodulator 305 inside the signal converter 201 under control of the signal converter 201.

As described above, the signal receiver 200 receives a radio frequency (RF) signal, i.e. a broadcast signal from the broadcasting station. The signal receiver 200 may be configured to receive the RF signal and output an intermediate frequency (IF) signal to be easily processed by the broadcast signal processing apparatus. To this end, the signal receiver 200 may include an RF-IF converter 310, and the RF-IF converter 310 may include a local oscillator for generating a specific frequency, and a mixer for removing a specific frequency from an RF broadcast signal.

The signal converter 201 may be configured to demodulate a received IF broadcast signal, and perform remodulation to be embedded in another carrier or conversion to have another transmission signal format. To this end, the signal converter 201 may include the demodulator 301, the remodulator 305, a first converter 307, and a second converter 309.

The demodulator 301 may demodulate an IF signal and output a transport stream (TS) signal. The demodulation may be performed in various ways depending on broadcast signal standards. For example, there are advanced television system committee (ATSC)-vertical sideband (VSB) standards proposed by the United States and used in the United States, Canada, Mexico; digital video broadcasting (DVB) used in Europe; integrated service digital broadcasting (ISDB) used in Japan, etc.

According to one embodiment of the present invention, the demodulator 301 may include an analog digital converter (ADC) for converting an analog signal received for the demodulation of the broadcast signal into a digital signal, a sync for synchronization of the signals, and a forward error correction (FEC) section 311 for correcting an error of a received signal.

The FEC section 311 employs low density parity check (LDPC), Reed Solomon, cyclic redundancy check (CRC), etc. as a coding technique for correcting a bit error in a communication line based on received information. When the received broadcast signal involves noise or the signal includes an error caused by deterioration or the like, the FEC section 311 serves to output the signal by correcting the error. The demodulator 301 may be configured to determine whether an error degree or error level of the received IF signal is lower than or equal to a predetermined level, and the operations of the first switch 300 and the second switch 303 may be varied depending on the determination results.

The signal converter 201 may further include a control means for controlling the broadcast signal processing apparatus 1 according to the present invention. The control means may be configured to control general operations of the broadcast signal processing apparatus 1, and particularly to control the operations of the first switch 300 and the second switch 303. The control means may be materialized as a system on chip (SoC), for example, a separate element in the signal converter 201, or an element integrated into the demodulator 301. The control means may control the operations of the first switch 300 and the second switch 303 based on an error level of a received broadcast signal determined by the demodulator 301. In more detail, the control means controls the first switch 300 to connect the signal receiver 200 and the first signal output section 203 when the error level of the received broadcast signal is lower than or equal to a predetermined level, and controls the second switch 303 to disconnect the demodulator 301 and the remodulator 305. The predetermined level is a preset threshold at which the apparatus capable of receiving the broadcast signal can display an image based on the received signal without problems.

For example, the control means determines that there are no needs of correcting an error up to an extent that an error degree of the received broadcast signal is higher than the threshold of visuality (ToV) by 2 dB or less, and controls the first switch 300 and the second switch 303 to bypass the signal converter 201, so that the bypassed broadcast signal can be transmitted as it is just amplified in the first signal output section 203.

The remodulator 305 outputs an IF signal by remodulating the TS output from the demodulator 301. The output IF signal may be embedded in a carrier different in frequency from the IF signal input from the signal receiver 200 to the signal converter 201. In other words, an idle frequency band corresponding to terminated analog broadcasting may be used, and thus interference between the input and output broadcast signals may be minimized because the input broadcast signal and the output broadcast signal are different in frequency from each other. The remodulation is performed according to standards as described above in the demodulation.

The IF signal subjected to the remodulation is converted into an RF signal in an IF-RF converter 312 of the first converter 307, and then the RF signal having a frequency selected through a filter 313 is provided to the first signal output section 203. Then, the first signal output section 203 transmits the RF signal to the outside. In this embodiment, the RF signal subjected to the remodulation and transmitted through the first signal output section 203 may refer to the first retransmission signal having a frequency different from that of the received broadcast signal in claims of the present application.

The second converter 309 is configured to receive a TS output from the demodulator 301, and convert the TS into a signal having a transmission signal format different from that of the received broadcast signal. The different transmission signal format may include a USB format and the like. The signal output from the second converter 309 and having the USB format is converted into a wireless fidelity (Wi-Fi) formation and then output through the second signal output section 205. That is, the signal converted to have the Wi-Fi format is output through a local network so that a personal computer, other mobile terminals, and the like incapable of receiving a TV or broadcast signal can receive the broadcast signal and display an image based on the broadcast signal. In this embodiment, the signal having the converted format and output through the second signal output section 205 may refer to the second retransmission signal having a transmission signal format different from that the received broadcast signal in claims of the present application.

The first signal output section 203 and the second signal output section 205 may respectively include a first amplifier 314 and a second amplifier 315 for amplifying the signals before transmitting the signals.

The broadcast signal received through the signal receiver 200 may be transmitted to the first signal output section 203 by bypassing the signal converter 201 in accordance with the operations of the first switch 300 and the second switch 303, and then output to the outside. In this case, the broadcast signal transmitted to the outside is the RF signal as it is received, which may be amplified by the first amplifier 314 and then output. In this embodiment, the broadcast signal transmitted bypassing the signal converter 201 may refer to a third retransmission signal in claims of the present application.

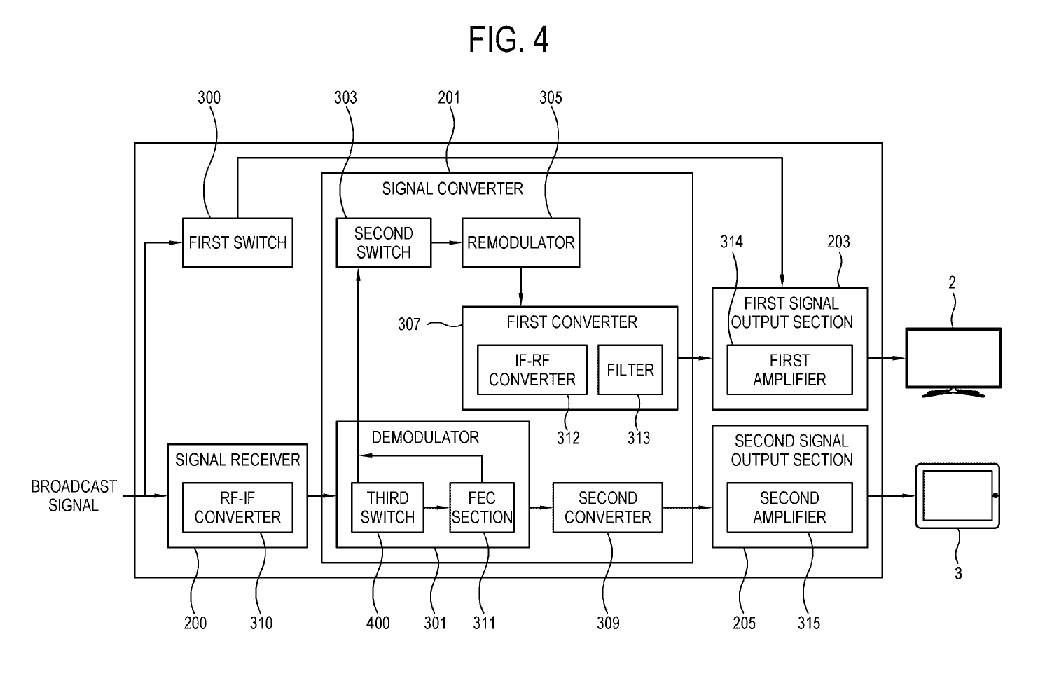

FIG. 4 is a block diagram of a broadcast signal processing apparatus according to one embodiment of the present invention. In this embodiment, the broadcast signal processing apparatus may make the received broadcast signal be input to the signal converter 201 and subjected to the demodulation and the remodulation even though the error degree of the received broadcast signal is lower than and equal to a predetermined level. To this end, the broadcast signal processing apparatus 1 may further include a third switch 400 inside the demodulator 301.

The control means determines the error degree of the received broadcast signal. The control means determines that there are no needs of correcting an error when the error degree is lower than and equal to a predetermined level, and controls the first switch 300 and the second switch 303 to make the received broadcast signal bypass the signal converter 201. However, the demodulator 301 in this embodiment may control the first switch 300 and the second switch 303 to make the received broadcast signal pass the signal converter 201 when a specific condition is satisfied even though it is determined that the error degree is lower than and equal to a predetermined level.

The specific condition may include a user's command, a control signal from the external apparatus, detection of frequency interference, or the like. The control means of the broadcast signal processing apparatus 1 may control the first switch 300 and the second switch 303 to make the received broadcast signal not bypass the signal converter 201 when a command of transmitting a broadcast signal at a certain frequency is issued by a user or received from an external apparatus even though the error degree of the received broadcast signal is lower than or equal to the threshold. Further, the broadcast signal processing apparatus 1 may also control the first switch 300 and the second switch 303 to make the broadcast signal pass the signal converter 201 so as to convert the frequency of the transmitted broadcast signal when frequency interference is sensed between the received broadcast signal and the transmitted broadcast signal. The frequency interference may be sensed by comparing the strength of the received broadcast signal and the strength of the transmitted broadcast signal. Besides, the external apparatuses capable of receiving a TV or broadcast signal and displaying an image may sense frequency interference and input a control signal to make a request for conversion of a frequency.

When the broadcast signal passes the signal converter 201 even though the error degree is lower than and equal to the threshold, the control means controls the third switch 400 to selectively bypass the FEC section 311. That is, the broadcast signal is subjected to the demodulation, but the error of the broadcast signal is not corrected since time is additionally taken. In this embodiment, the FEC section 311 is illustrated as a separated element for convenience of description, but not limited thereto.

According to another embodiment, the demodulator 301 may perform a function of correcting an error, and a specific flag may control the demodulator 301 not to perform a function of error correction when a specific condition is satisfied and thus the broadcast signal is received even though the error degree is lower than and equal to the threshold

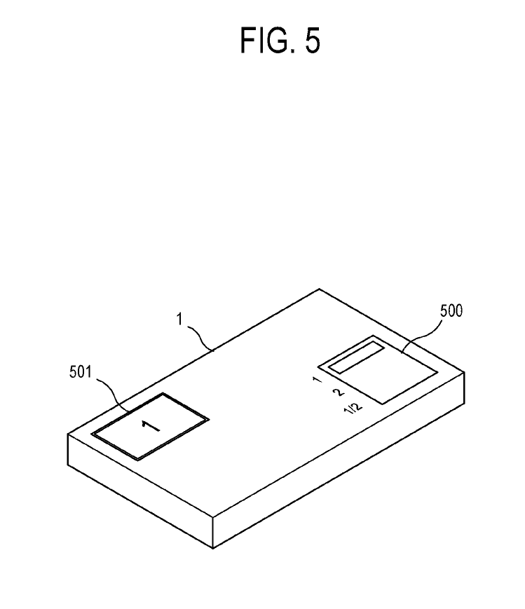

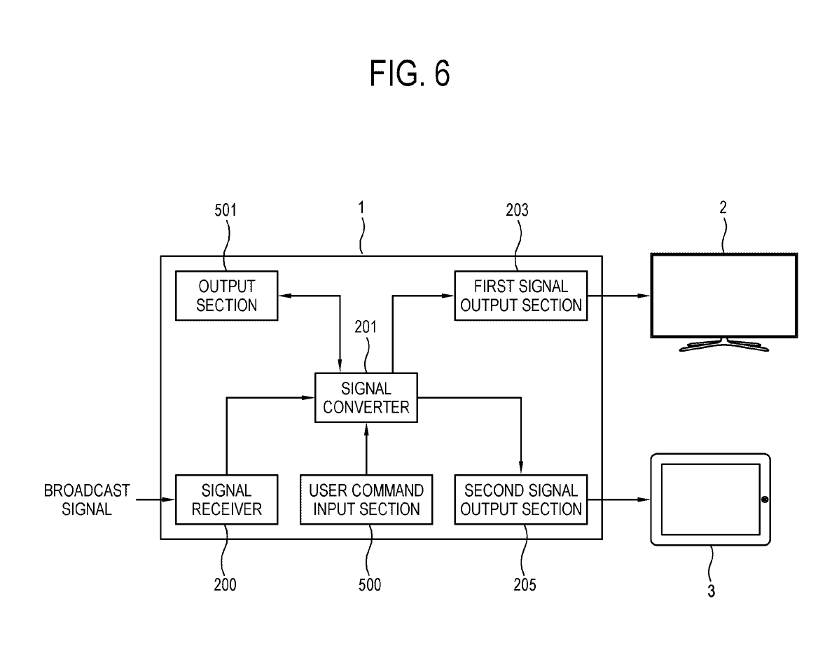

FIGS. 5 and 6 are a perspective view and a block diagram of a broadcast signal processing apparatus according to one embodiment of the present invention. The broadcast signal processing apparatus 1 in this embodiment is configured to transmit at least one of the first retransmission signal changed in frequency from the received broadcast signal and the second retransmission signal changed in the transmission signal format based on a user's selection or the like, and provide information about the kind of transmitted signal to a user. To this end, the broadcast signal processing apparatus 1 in this embodiment may further include an output section 501 and a user command input section 500.

The user command input section 500 may directly receive a control command through a control panel, or may receive a remote control signal including a user's control command from a remote controller. The user command input section 500 may be materialized by a touch pad, and may also be materialized by a touch screen for sensing a user's touch input on a display of the broadcast signal processing apparatus 1. The user command input section 500 may further include a microphone or the like for recognizing a user's voice command. In this embodiment, the broadcast signal processing apparatus 1 selectively converts the received broadcast signal into one of the first retransmission signal having a different frequency and the second retransmission signal having a different transmission signal format in response to a user's input to the user command input section 500 or the like, and transmits the converted signal through corresponding one of the first signal output section 203 and the second signal output section 205.

The output section 501 is configured to provide various pieces of information to a user. In this embodiment, the output section 501 provides a user with information about the kind of signal converted by and transmitted from the signal converter 201, i.e. information about whether the received broadcast signal is converted and transmitted as the first retransmission signal having the converted frequency or the second retransmission signal. The output section 501 may include one of a built-in loudspeaker for outputting related information as a sound based on and a display for displaying the related information as visual information.

According to another embodiment, a user may input a control command to the user command input section 500 so that the signal converter 201 can be bypassed not to use the signal converting function of the broadcast signal processing apparatus 1, or a user may be informed that the third retransmission signal is transmitted by amplifying the received broadcast signal, through the output section 501 when the error degree of the broadcast signal is lower than or equal to the threshold.

According to sill another embodiment, a user may input a control command so that the received broadcast signal can be output having a convert frequency without error correction though the output section 501 even though the error degree of the broadcast signal is lower than or equal to the threshold, a control signal may be received from the external apparatuses 2 and 3, or frequency interference may be detected. In this case, the broadcast signal processing apparatus 1 transmits the first retransmission signal by converting the frequency of the received broadcast signal without correcting the error, and provides the related information to a user through the output section 501.

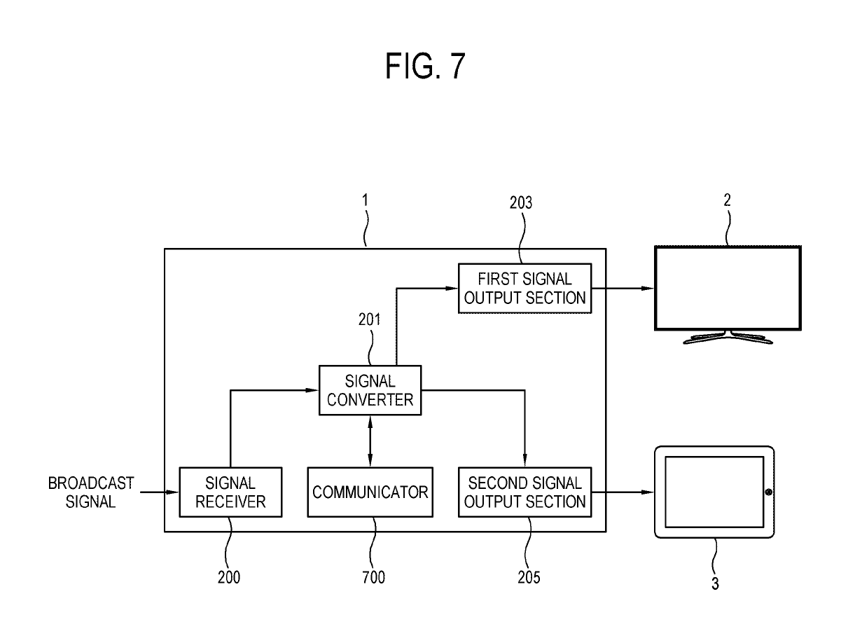

FIG. 7 is a block diagram of a broadcast signal processing apparatus further comprising a communicator according to one embodiment of the present invention. In this embodiment, the broadcast signal processing apparatus may further include a communicator 700 capable of communicating with the external apparatuses 2 and 3.

The communicator 700 is configured to make the broadcast signal processing apparatus 1 communicate with the plurality of external apparatuses directly or via a network or the like, and may include a plurality of connection ports according to various standards such as high definition multimedia interface (HDMI), a universal serial bus (USB), etc. The communicator 700 may perform wired communication with a plurality of servers through a wired local area network (LAN). The communication performed in the communicator 700 may include wireless communication. In case of the wireless communication, the communicator 700 may include a radio frequency (RF) circuit for transmitting and receiving an RF signal. The communicator 700 may perform the wireless communication through a wireless network by a wireless LAN, wireless fidelity (Wi-Fi), etc. In addition, the communicator 700 may perform the wireless communication with the external device or network by Bluetooth or the like. Further, the communicator 700 may additionally perform communication for voice over Internet protocol (VoIP), message transceiving, etc.

Through the communicator 700, the external apparatuses 2 and 3 may transmit a control signal to the broadcast signal processing apparatus 1 to thereby output a desired retransmission signal.

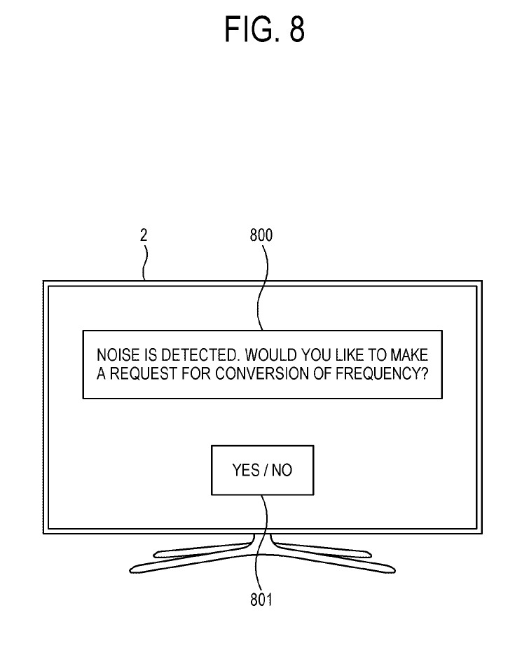

FIG. 8 shows a screen of an external apparatus that receives a broadcast signal according to one embodiment of the present invention.

The external apparatus 2 receiving the broadcast signal and displaying an image based on the received broadcast signal may transmit a control signal to the broadcast signal processing apparatus 1 so as to output the broadcast signal by correcting the error or converting the frequency when the noise is detected in the received broadcast signal or when the broadcast signal is weak. Before transmitting the control signal, the external apparatus 2 may show a user a user interface (UI) including a guide 800 of asking a user about request for conversion of frequency due to detection of noise, and a confirmation item 801. A user selects the confirmation item 801 to thereby approve of the request for the frequency conversion.

In response to the request of the external apparatus 2 for the frequency conversion, the broadcast signal processing apparatus 1 corrects the error of the received broadcast signal, or converts the frequency without correcting the error, thereby transmitting the broadcast signal through the first signal output section 203.

In this embodiment, the frequency conversion is requested due to detection of noise. Alternatively, the frequency conversion may be requested when the received broadcast signal is weak.

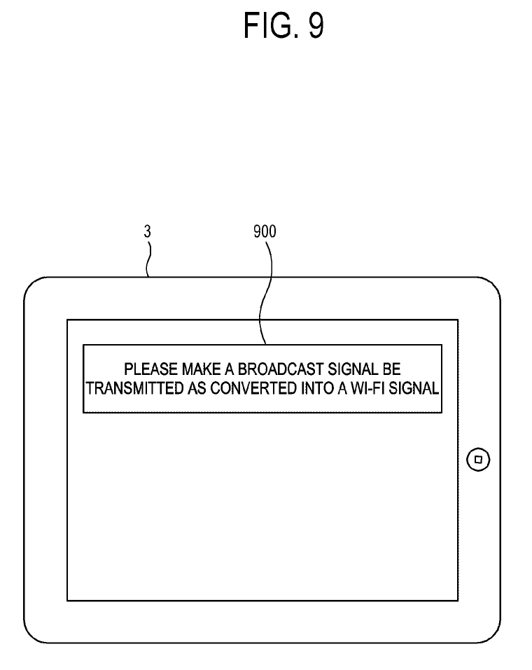

FIG. 9 shows a screen of an external apparatus that receives a broadcast signal according to one embodiment of the present invention. In this embodiment, the external apparatus 3 cannot directly receive a broadcast signal from the outside, but can display an image based on image data received through a network. In this embodiment, the external apparatus 3 may be materialized by a personal computer, a laptop computer, a portable terminal, and the like apparatus incapable of directly receiving a broadcast signal but capable of receiving data through a network connected by a wire or wirelessly.

To display an image based on image data of a broadcast signal having a Wi-Fi format and received through a local network, the external apparatus 3 may transmit a control signal to the broadcast signal processing apparatus 1 so that the broadcast signal processing apparatus 1 can output the second retransmission signal by converting the transmission signal format of the received broadcast signal. Before transmitting the control signal, the external apparatus 3 may display a guide 900 of asking a user about whether to convert the broadcast signal into the Wi-Fi signal.

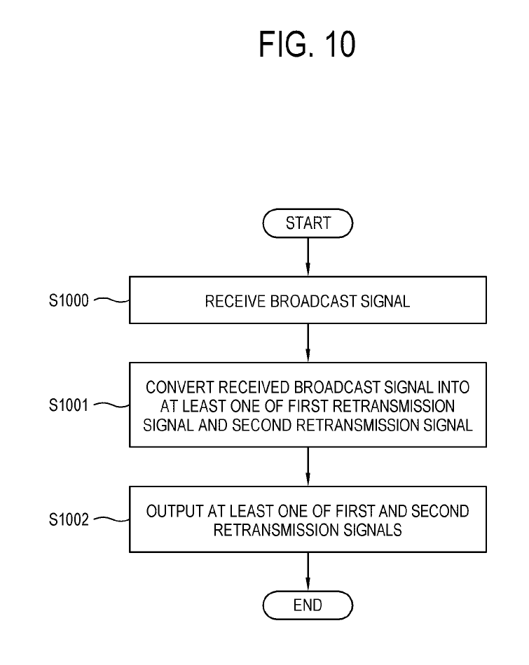

FIG. 10 is a flowchart of controlling a broadcast signal processing apparatus according to one embodiment of the present invention.

First, at operation S1000, the signal receiver 200 receives a broadcast signal. Then, at operation S1001, the signal converter 201 converts the received broadcast signal into at least one of the first retransmission signal and the second retransmission signal. Last, at operation S1002, the first signal output section 203 or the second signal output section 205 transmits at least one corresponding to the first retransmission signal or the second retransmission signal to the outside.

The signal receiver 200 receives a broadcast signal from a broadcasting station, a relay or the like (S1000). The received RF signal, i.e. the broadcast signal is converted into an IF signal and transmitted to the signal converter 201.

The signal converter 201 receives the IF signal, and converts it into a TS, i.e. the first retransmission signal having a different frequency or the second retransmission signal having a different transmission signal format (S1001). The TS of the first retransmission signal is converted into the RF signal of the first retransmission signal in the signal converter 201 and transmitted to the first signal output section 203. The TS of the second retransmission signal is converted from the USB format into the Wi-Fi format, and transmitted to the second signal output section 205.

The first signal output section 203 or the second signal output section 205 transmits the corresponding first or second retransmission signal to the outside (S1002). The signal converter 201 receives a control signal from a user or the external apparatuses 2 and 3, converts the received broadcast signal into the first retransmission signal or the second retransmission signal, and provides the first retransmission signal or the second retransmission signal to the first or second signal output section. The first signal output section 203 and the second signal output section 205 transmit the first retransmission signal or the second retransmission signal to the outside (S1002).

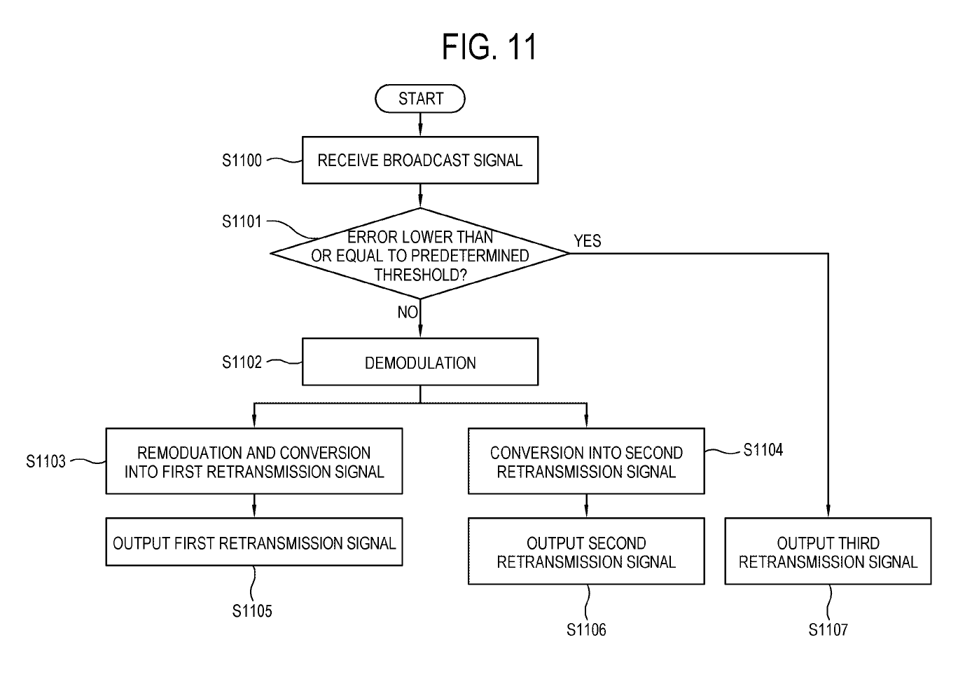

FIG. 11 is a flowchart of controlling a broadcast signal processing apparatus according to one embodiment of the present invention. In this embodiment, the broadcast signal processing apparatus 1 determines an error degree of a received broadcast signal, determines whether to make the received broadcast signal bypass the signal converter 201 in accordance with the error degrees, and outputs the retransmission signal. First, at operation S1100, the signal receiver 200 receives a broadcast signal. Then, at operation S1101, the signal converter 201 determines the error degree of the received broadcast signal. When the error degree exceeds a predetermined threshold, at operation S1102 the demodulator 301 performs demodulation. Then, at operation S1103, the remodulator 305 performs remodulation. Further, at operation S1105 the first signal output section 203 outputs the first retransmission signal to the outside. At operation S1106, the second signal output section 205 outputs the second retransmission signal to the outside. Last, when the error degree is lower than or equal to a predetermined threshold, the first signal output section 203 outputs a third retransmission signal of the received broadcast signal to the outside.

The control means of the signal converter 201 determines whether the error degree of the received broadcast signal is a predetermined threshold or not (S1101). Then, the control means control the first switch 300 and the second switch 303 in accordance with the determined error degree, thereby selectively forming or blocking a transmission path of the broadcast signal. When the determined error degree is lower than or equal to a predetermined threshold, the received broadcast signal is transmitted to the first signal output section 203 by bypassing the signal converter 201, and output as the third retransmission signal to the outside (S1107).

When the determined error degree is equal to or higher than a predetermined threshold, the received broadcast signal is transmitted to the signal converter 201. The broadcast signal received and converted into the IF signal is first subjected to the demodulation in the demodulator (S1102). The demodulation includes analog-digital conversion, synchronization, error correction, etc., and desired video and audio information is extracted from the received broadcast signal and converted into a TS including data.

The TS is transmitted to the remodulator 305. The remodulator 305 performs the remodulation of embedding the demodulated TS in a carrier to be transmitted to the outside, thereby converting it into the IF signal (S1103). In this case, the converted IF signal may include a carrier of a frequency different from that of the received broadcast signal.

The converted IF signal is converted into an RF signal in the first converter 307 and transmitted as the first retransmission signal to the outside through the first signal output section 203 (S1105).

The demodulated TS is transmitted to the second converter 309. The TS is converted to have a USB format or a Wi-Fi format (S1104), and transmitted as the second retransmission signal to the outside through the second signal output section 205 (S1106).

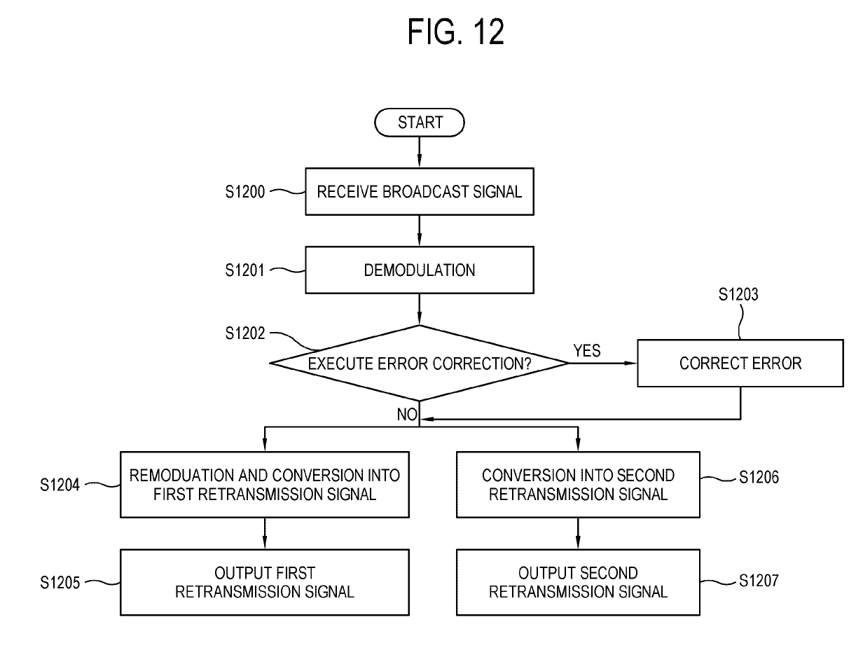

FIG. 12 is a flowchart of controlling a broadcast signal processing apparatus according to one embodiment of the present invention. In this embodiment, the broadcast signal processing apparatus 1 may control the broadcast signal to pass the signal converter 201 without correcting an error in accordance with a specific condition when the specific condition is satisfied even when the error degree of the received broadcast signal is lower than or equal to a threshold. First, at operation S1200, the signal receiver 200 receives a broadcast signal from the outside. Then, at operation S1201, the received broadcast signal is subjected to the demodulation in the demodulator 301. Further, at operation S1202, the signal converter 201 determines whether the received broadcast signal has to be subjected to error correction. When there is a need of correcting an error, at operation S1203, the error of the received broadcast signal is corrected and output. When there are no needs of correcting the error, or after correcting the error, at operation S1204 the received broadcast signal is subjected to the remodulation in the remodulator 305 and converted into the first retransmission signal. Further, at operation S1205, the first signal output section 203 transmits the converted first retransmission signal to the outside. Further, at operation S1206, the second converter 309 converts the received broadcast signal into the second retransmission signal having a different transmission signal format. Last, at operation S1207, the second signal output section 205 transmits the converted second retransmission signal to the outside.

Although the control means determines that the error degree is lower than or equal to a predetermined threshold, the broadcast signal processing apparatus 1 may convert the frequency of the received broadcast signal under control of a user or in response to a control signal from the external apparatus.

The received broadcast signal is transmitted to the signal converter 201 through the signal receiver 200, and subjected to the demodulation in the demodulator 301 (S1201).

Then, the control means selectively controls the third switch 400 so that the broadcast signal can bypass the FEC section 311 in accordance with whether there is a need of correcting the error of the received broadcast signal.

For example, when the broadcast signal is transmitted to the signal converter 201 since the signal has a high error degree, the third switch 400 is controlled to make the broadcast signal not bypass the FEC section 311. On the other hand, when the broadcast signal is transmitted to the signal converter 201 since a specific condition is satisfied even though the signal has a low error degree, the third witch 400 is controlled to make the broadcast signal bypass the FEC section 311.

In this embodiment, the demodulation is performed, and then the error correction or bypassing is performed as if the demodulation and the error correction are performed in sequence. However, this is only for illustrative purposes to make the description easier. Alternatively, both the demodulation and the error may be performed at a time. That is, the error may be corrected while the received IF signal is converted into the TS. When it is selected not to correct the error, the demodulation will be performed without correcting the error.

Then, the remodulator 305 remodulates the demodulated TS into the IF signal (S1204), and the IF signal is converted into an RF signal by the first converter and transmitted to the first signal output section 203. The RF signal, i.e. the first retransmission signal is output to the outside by the first signal output section 203 (S1205).

In addition, the demodulated TS is transmitted to the second converter 309, and the second converter 309 converts the received TS into the second retransmission signal having a different transmission signal format (S1206). The second retransmission signal converted to have the Wi-Fi format or the like is transmitted to the outside through the second signal output section 205 (S1207).

1. A broadcast signal processing apparatus comprising:
a signal receiver configured to receive a broadcast signal;
a signal converter configured to convert and output the received broadcast signal into at least one of a first retransmission signal different in frequency from the received broadcast signal and a second retransmission signal different in signal transmission format from the received broadcast signal;
a first signal output section configured to output the first retransmission signal; and
a second signal output section configured to output the second retransmission signal.

2. The broadcast signal processing apparatus according to claim 1, wherein the signal converter comprises a demodulator configured to perform demodulation with regard to the received broadcast signal.

3. The broadcast signal processing apparatus according to claim 2, wherein the demodulator comprises a forward error correcting (FEC) section configured to correct an error.

4. The broadcast signal processing apparatus according to claim 2, wherein the signal converter comprises a remodulator configured to remodulate and output the demodulated broadcast signal into the first retransmission signal.

5. The broadcast signal processing apparatus according to claim 2, wherein the signal converter further comprises a converter configured to convert the demodulated broadcast signal into the second retransmission signal.

6. The broadcast signal processing apparatus according to claim 1, further comprising a first switch configured to selectively connect the signal receiver and the first signal output section while bypassing the signal converter,
wherein the first signal output section outputs a third retransmission signal of the broadcast signal received through the first switch.

7. The broadcast signal processing apparatus according to claim 6, wherein the signal receiver and the first signal output section are connected through the first switch when an error degree of the broadcast signal is lower than or equal to a predetermined threshold.

8. The broadcast signal processing apparatus according to claim 7, further comprising a second switch configured to selectively connect the demodulator and the remodulator,
wherein the second switch disconnects the demodulator and the remodulator when the signal receiver and the first signal output section are connected through the first switch.

9. The broadcast signal processing apparatus according to claim 3, wherein the demodulator further comprises a third switch configured to make the received broadcast signal selectively bypass the FEC section.

10. The broadcast signal processing apparatus according to claim 1, further comprising a user command input section,
wherein the signal converter converts and outputs the broadcast signal into at least one of the first retransmission signal and the second retransmission signal based on a user's control command input through the user command input section.

11. The broadcast signal processing apparatus according to claim 1, wherein the signal converter converts and outputs the broadcast signal into at least one of the first retransmission signal and the second retransmission signal based on characteristics of an external signal receiving apparatus.

12. The broadcast signal processing apparatus according to claim 11, wherein the characteristics of the external signal receiving apparatus comprise a type of signal processible by the external signal receiving apparatus.

13. The broadcast signal processing apparatus according to claim 11, wherein the characteristics of the external signal receiving apparatus comprise a request of the external signal receiving apparatus for the first retransmission signal or the second retransmission signal to the signal converter.

14. The broadcast signal processing apparatus according to claim 1, wherein the signal converter converts and outputs the broadcast signal into at least one of the first retransmission signal and the second retransmission signal based on characteristics of the received broadcast signal.

15. A method of controlling a broadcast signal processing apparatus, comprising:
by a signal receiver, receiving a broadcast signal and outputting the broadcast signal to a signal converter;
by a signal converter, converting the received broadcast signal into at least one of a first retransmission signal different in frequency from the received broadcast signal and a second retransmission signal different in signal transmission format from the received broadcast signal, and outputting the converted broadcast signal to corresponding output section; and
by a first signal output section or a second signal output section, outputting at least one of the corresponding retransmission signals.
